(19) United States
(12) Patent Application Publication
(10) Pub. No.: US 2017/0054475 A1
(43) Pub. Date: Feb. 23, 2017

(54) COIL ANTENNA DEVICE, ELECTRONIC APPARATUS WITH COIL ANTENNA DEVICE, AND METHOD OF PRODUCING COIL ANTENNA DEVICE

(71) Applicants: Naohiro ITOH, Hyogo (JP); Takashi OTSUKI, Hyogo (JP)

(72) Inventors: Naohiro ITOH, Hyogo (JP); Takashi OTSUKI, Hyogo (JP)

(21) Appl. No.: 15/225,213

(22) Filed: Aug. 1, 2016

(30) Foreign Application Priority Data
Aug. 21, 2015 (JP) 2015-163582

(51) Int. Cl. H04B 5/00

(52) U.S. Cl. CPC H04B 5/0087; H04B 5/0037

(57) ABSTRACT

A coil antenna device includes a planar magnetic body and a conducting wire wound around the planar magnetic body multiple times as a coil having a prescribed length in a direction parallel to a long side of the magnetic body. The magnetic body includes at least one irregular portion having a different cross-sectional shape from a cross-sectional shape of another portion of the magnetic body at an intermediate position of the long side of the magnetic body, at which the conducting wire is wound around the magnetic body. The at least one irregular portion extends parallel to a short side of the magnetic body.

### CROSS-REFERENCE TO RELATED APPLICATION

This patent application is based on and claims priority pursuant to 35 U.S.C. §119(a) to Japanese Patent Application No. 2015-163582 filed on Aug. 21, 2015 in the Japan Patent Office, the entire disclosure of which is hereby incorporated by reference herein.

### BACKGROUND

Technical Field

Embodiments of the present invention relate to a coil antenna device, an electronic apparatus with the coil antenna device, and a method of producing the coil antenna device.

Related Art

Mobile phones, smartphones, and tablets or the like employing near field wireless communication (NFC) are currently in widespread use, and are enabled to wirelessly communicate with each other simply by holding up and bring the electronic apparatuses close together. That is, each of the electronic apparatuses generally includes an antenna device that employs a short-range magnetic coupling system, with which communications are established by mutually approximating the antenna devices in a magnetic field to magnetically couple antenna devices with each other. As performance of each of the apparatuses is increasingly enhanced and the apparatus is downsized, there is a demand for downsizing of the antenna devices as well.

### SUMMARY

One aspect of the present disclosure provides a novel coil antenna device that includes a planar magnetic body and a conducting wire wound around the planar magnetic body multiple times as a coil having a prescribed length in a direction parallel to a long side of the magnetic body. The magnetic body includes at least one irregular portion having a different cross-sectional shape from a cross-sectional shape of another portion of the magnetic body at an intermediate position of the long side of the magnetic body, at which the conducting wire is wound around the magnetic body. The at least one irregular portion extends parallel to a short side of the magnetic body.

Another aspect of the present disclosure provides a novel electronic apparatus that includes the above-described coil antenna device. The coil antenna device either wirelessly establishes communications or wirelessly supplies electricity to another coil antenna device located within a short range acting as either a communications counterpart or an electric power supply destination, respectively.

Yet another aspect of the present disclosure provides a novel method of producing a coil antenna device that wirelessly establishes communications or supplies electricity to another coil antenna device located within a short range. The method includes the steps of forming at least one groove, at least one projection, or at least one through hole in a planar magnetic body parallel to a short side of the planar magnetic body at an intermediate position of a long side of the planar magnetic body, winding a conducting wire around the planar magnetic body multiple times over the at least one groove, the at least one projection, or the at least one through hole as a coil, and connecting both ends of the conducting wire wound around the planar magnetic body to a communication unit and forming a magnetic field on the planar magnetic body by generating a first magnetic flux extending from one end to another end of the coil of the coil antenna device and a second magnetic flux extending from the one end of the coil of the coil antenna device to the intermediate position of the long side of the planar magnetic body.

### BRIEF DESCRIPTION OF THE DRAWINGS

A more complete appreciation of the present disclosure and many of the attendant advantages of the present disclosure will be more readily obtained as substantially the same becomes better understood by reference to the following detailed description when considered in connection with the accompanying drawings, wherein:

FIG. 1 is a perspective view illustrating an exemplary antenna device according to a first embodiment of the present invention;

FIGS. 2A, 2B, and 2C are front, side, and plan views, respectively, collectively illustrating the antenna device of the first embodiment of the present invention as illustrated in FIG. 1;

FIG. 3 is a diagram illustrating a simulation result of generating a magnetic field in a conventional antenna device;

FIG. 4 is also a diagram illustrating a simulation result of generating a magnetic field in the antenna device illustrated in FIGS. 1, 2A, 2B, and 2C according to one embodiment of the present invention;

FIGS. 5A, 5B, and 5C are front, side, and plan views, respectively, collectively illustrating another exemplary antenna device of a second embodiment of the present invention;

FIG. 6 is a diagram illustrating a simulation result of generating a magnetic field in the exemplary antenna device of the second embodiment of the present invention illustrated in FIGS. 5A, 5B, and 5C;

FIGS. 7A, 7B, and 7C are front, side, and plan views, respectively, collectively illustrating yet another exemplary antenna device of a third embodiment of the present invention;

FIG. 8 is a diagram illustrating a simulation result of generating a magnetic field in the exemplary antenna device of the third embodiment of the present invention illustrated in FIGS. 7A, 7B, and 7C;

FIGS. 9A, 9B, and 9C are front, side, and plan views, respectively, collectively illustrating yet another antenna device of a fourth embodiment of the present invention;

FIG. 10 is a diagram illustrating a simulation result of generating a magnetic field in the exemplary antenna device of the fourth embodiment of the present invention illustrated in FIGS. 9A, 9B, and 9C;

FIGS. 11A, 11B, and 11C are front, side, and plan views, respectively, collectively illustrating yet another exemplary antenna device of a fifth embodiment of the present invention;

FIG. 12 is a diagram illustrating a simulation result of generating a magnetic field in the exemplary antenna device of the fifth embodiment of the present invention illustrated in FIGS. 11A, 11B, and 11C;

FIGS. 13A, 13B, and 13C are front, side, and plan views, respectively, collectively illustrating yet another exemplary antenna device of a sixth embodiment of the present invention;

FIG. 14 is a diagram illustrating a simulation result of generating a magnetic field in the exemplary antenna device of the sixth embodiment of the present invention illustrated in FIGS. 13A, 13B, and 13C;

FIGS. 15A, 15B, and 15C are front, side, and plan views, respectively, collectively illustrating yet another exemplary antenna device of a seventh embodiment of the present invention;

FIG. 16 is a diagram illustrating a simulation result of generating a magnetic field in the exemplary antenna device of the seventh embodiment of the present invention illustrated in FIGS. 15A, 15B, and 15C;

FIGS. 17A, 17B, and 17C are front, side, and plan views, respectively, collectively illustrating yet another exemplary antenna device of an eighth embodiment of the present invention;

FIG. 18 is a diagram illustrating a simulation result of generating a magnetic field in the exemplary antenna device of the eighth embodiment of the present invention illustrated in FIGS. 17A, 17B, and 17C;

FIGS. 19A, 19B, and 19C are front, side, and plan views, respectively, collectively illustrating yet another exemplary antenna device of a ninth embodiment of the present invention;

FIG. 20 is a diagram illustrating a simulation result of generating a magnetic field in the exemplary antenna device of the ninth embodiment of the present invention illustrated in FIGS. 19A, 19B, and 19C;

FIG. 21 is a diagram schematically illustrating a first exemplary electronic apparatus that employs one of the above-described various embodiments of the antenna device according to a tenth embodiment of the present invention; and

FIG. 22 is a diagram schematically illustrating a second exemplary electronic apparatus that employs one of the above-described various embodiments of the antenna device according to an eleventh embodiment of the present invention.

### DETAILED DESCRIPTION

As a typical antenna device that establishes communications in a magnetic field, a loop antenna produced by winding a conducting wire into a coil state is used. However, since performance of the loop antenna is easily affected by metal, a magnetic field is sometimes cancelled by the metal when the metal exists in the magnetic field near the loop antenna. As a result, either a communication range of an electronic apparatus that employs such a loop antenna becomes narrower or communications themselves become impossible sometimes.

To solve such problems and widen the communication range even though the metal exists near the loop antenna, a typical antenna device employs a magnetic body around which a coil winds to suppress affection from the metal

However, when communications are established between two short-range magnetic coupling systems respectively including such antenna devices (i.e., produced by winding the coil around the magnetic body) by bringing one of the antenna devices to the other one of antenna devices acting as a communications counterpart, magnetic coupling is sometimes hardly established at a prescribed portion of the other one of the antenna devices depending on a position of one of the antenna devices, resulting in erroneous communications.

Such defective magnetic coupling similarly occurs between wireless electric power supply systems, between which electricity is wirelessly supplied to a communications counterpart, as well.

That is, in the systems, a range (i.e., an area) possible to successfully wirelessly establish communications and that possible to successfully establish wireless electric power supply may be narrowed, respectively.

For this reason, novel antenna devices capable of widely establishing wireless communication and wireless electric power supply are demanded, respectively.

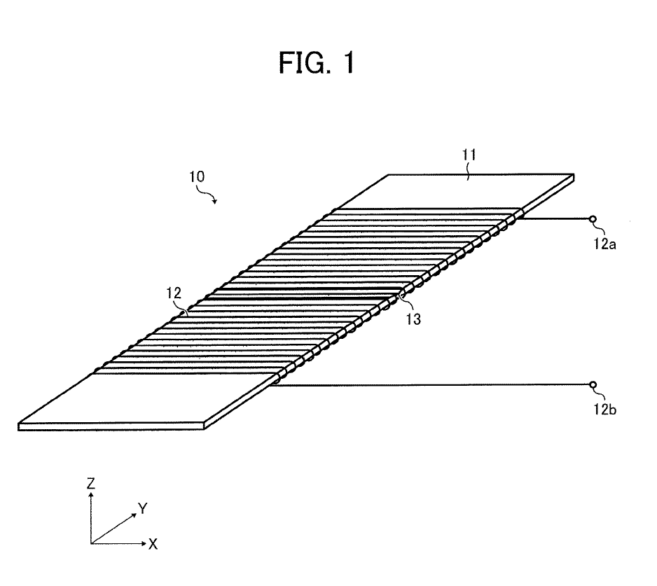

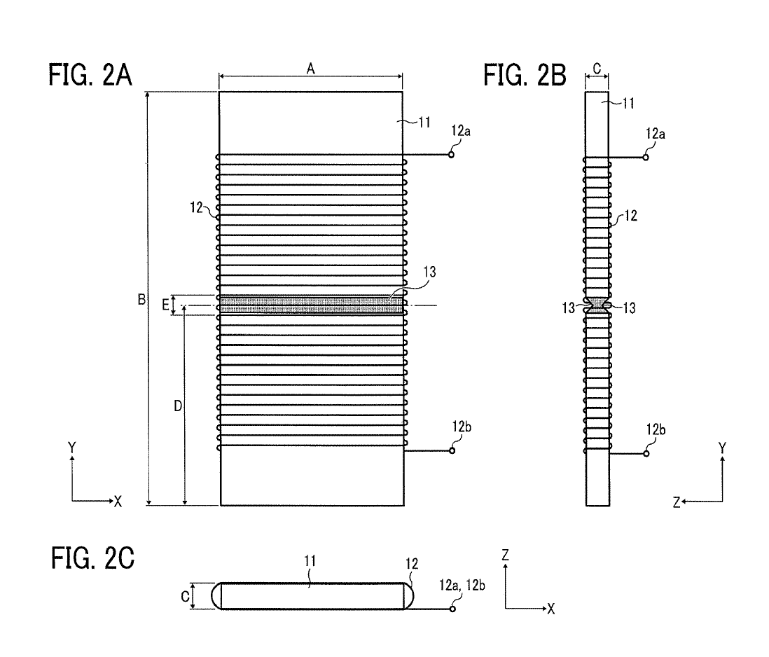

Referring now to the drawings, wherein like reference numerals designate identical or corresponding member throughout the several views of the drawings, and in particular to FIG. 1, an exemplary antenna device 10 that wirelessly establish either communication or electric power supply is illustrated according to a first embodiment of the present invention. FIGS. 2A, 2B, and 2C collectively illustrate front, side, and side views of the antenna device 10 of the first embodiment of the present invention of FIG. 1. As illustrated in FIGS. 1, 2A, 2B, and 2C, an XYZ orthogonal coordinate system is indicated together with the antenna device 10 to define three orthogonal directions of the antenna device 10. Specifically, the antenna device 10 includes a planar magnetic body 11 and a conducting wire 12 wound around the magnetic body 11 in a spiral state. That is, the conducting wire 12 is wound around the magnetic body 11 to form a coil on the magnetic body.

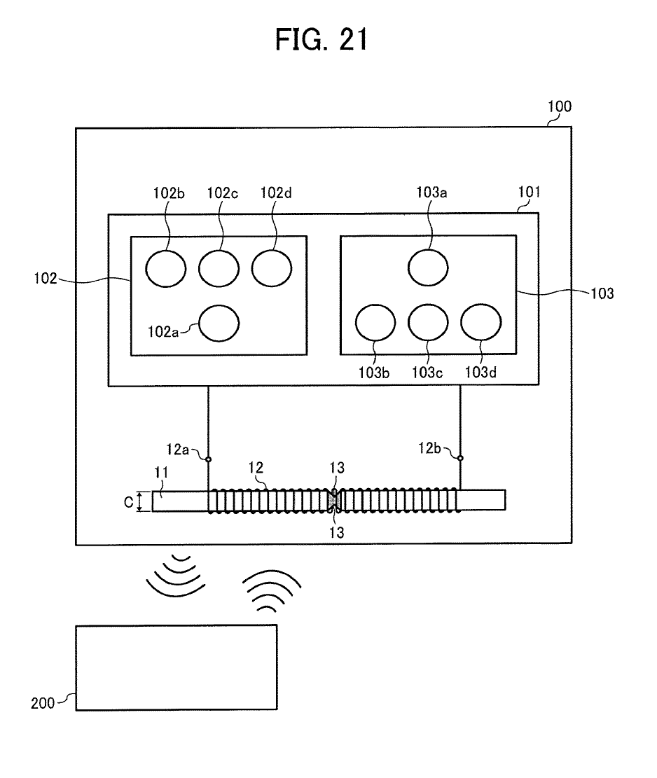

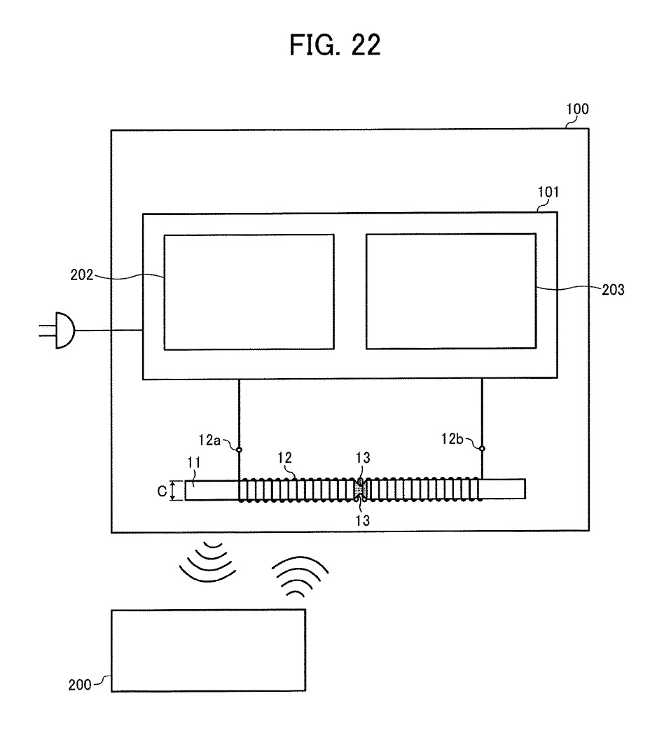

Both ends 12a and 12b of the conducting wire 12 are connected to a communication unit 101 of an electronic apparatus 100 that establishes wireless communication and wireless electric power supply by using the antenna device 10 illustrated in FIGS. 21 and 22. To wirelessly establish communications between a pair of the electronic apparatus 100 and an electronic apparatus 200, the communication unit 101 of the electronic apparatus 100 can be configured by a transmitter 102 that transmits data to the electronic apparatus 200 and a receiver 103 that receives data from the electronic apparatus 200. The transmitter 102 includes, e.g., a modulator circuit 102a, a demodulator circuit 102b, a memory circuit 102c, and a control circuit 102d. The receiver 103 similarly includes, e.g., a modulator circuit 103a, a demodulator circuit 103b, a memory circuit 103c, and a control circuit 103d. Since each of the transmitter 102 and the receiver 103 is well-known, further details of the transmitter 102 and the receiver 103 are not described herein below.

When executing wireless electric power supply to and from the electronic apparatus 200, the communication unit 101 of the electronic apparatus 100 may include an electric power supply circuit 202 and a power receiving circuit 203. Hence, the communication unit 101 is connected to a commercial use alternating current (AC) electric power supply. Again, the electric power supply and receiving circuits are well-known and are not detailed herein below.

Various devices may be used as the electronic apparatus 100 to establish both the wireless communication and the wireless electric power supply by using the antenna device 10. That is, to establish wireless communication the electronic apparatus 100 can be any one of a radio frequency identification (RFID) tag, an integrated circuit (IC) card, a radio frequency identification (RFID) reader-writer, a mobile phone, a smartphone, a tablet terminal, a laptop personal computer (PC), a personal digital assistant (PDA), and a game console or the like, for example. To establish wireless electric power supply the electronic apparatus 100 can be any one of an electric toothbrush, an electric shaver, a cordless phone, a cordless iron, an electric bed, an electric car, an electric wheelchair, and an electric bicycle or the like. However, the electronic apparatus 100 is not limited to the above-described examples and includes variants of the above-described examples. Now, the antenna device 10 that establishes wireless communication is herein below typically described in greater detail with reference to FIG. 1 and applicable drawings.

That is, the antenna device 10 employs a short-range magnetic coupling system and does not employ a resonant antenna device that transmits or receives an electric wave having a prescribed frequency by causing resonance with the electric wave. That is, the antenna device 10 communicates with another antenna device acting as a communications counterpart included in a counterpart electronic apparatus 200 by magnetically connecting with a magnetic flux generated by the other antenna device of the communications counterpart included in a counterpart electronic apparatus 200. Although the resonant antenna device has a communication range of from about a few meters to about a few kilometers, the antenna device 10 of the short-range magnetic coupling system has that of about 1 meter. That is, the antenna device 10 is used in establishing short-range communications. The antenna device 10 is enabled to transmit and receive a signal having a frequency of about 13.56 MHz, for example.

The planar magnetic body 11 can be made of sintered ferrite and has a rectangular solid shape. The magnetic body 11 has two largest planes at front and rear surfaces among six planes of the rectangular solid shape. A short side of each of the two largest planes (i.e., a side in an axial direction indicated by X) has a length A of about 3 mm, whereas a long side of each of the two largest planes (i.e., a side in an axial direction indicated by Y) has a length B of about 0.15 mm. A thickness (i.e., a length C in an axial direction indicated by Z) of the magnetic body 11 also is about 12 mm as well. These dimensions are only typical examples, and the length A in the axial direction indicated by X can be about 6 mm, and the length B in the axial direction indicated by Y can be about 24 mm. The length in the axial direction indicated by Z can also be about 0.2 mm as well, for example. That is, as long as the magnetic body 11 has a planar shape, the dimensions of the magnetic body 11 can be optionally determined depending on either a size or a shape and the like of a space for implementing the antenna device 10.

Material of the magnetic body 11 is not limited to the above-described sintered ferrite, and can be ferromagnetic, such as iron, iron oxide, chromium oxide, cobalt, nickel, alloys of the materials, etc. Although the above-described magnetic body 11 of the planar shape is generally thick and is hard, the magnetic body 11 is not limited to such a planer shape and may be a flexible sheet as well.

The conducting wire 12 can employ material to enable electric current to easily flow in the conducting wire 12, and can be made of copper, silver, gold, and conductive polymers or the like, for example. An optimal diameter of the conducting wire can be determined by considering skin effect. When the conducting wire 12 is used to transmit a signal of the above-described frequency of about 13.56 MHz, the diameter of the conducting wire 12 can be about 50 μm, for example. The number of times the conducting wire 12 wound around the magnetic body 11 can be set to about thirty, for example. The conducting wire 12 is evenly wound around the magnetic body 11 at a prescribed interval so that conducting wires 12 neighboring to each other are spaced without contacting each other. Hence, the prescribed interval can be set to about 0.25 mm, for example. A method of winding the conducting wire 12 illustrated in FIGS. 1, 2A, 2B, and 2C is called rough winding, because the conducting wire 12 is wound around the magnetic body 11 at a prescribed interval.

To obtain insulation while preventing the conducting wire 12 from corrosion, the conducting wire 12 can be coated with enamel. In such a situation, a diameter of the enameled conducting wire 12 may be set to about 69 μm, for example. The diameter and the number of winding times of the conducting wire 12 are not limited to the above-described levels, and can be determined depending on usage of the antenna device 10 or the like.

In this embodiment of the present invention, the magnetic body 11 of the antenna device is subjected to a surface machining process. That is, the antenna device 10 of this embodiment of the present invention may include one or more projections, grooves, or both of the projections and the grooves extending on one side of the magnetic body 11 parallel to a short side of the magnetic body 11. Otherwise, the antenna device 10 of this embodiment of the present invention may include one or more through holes penetrating the magnetic body 11 from a front side to a rear side of the magnetic body 11 while extending parallel to the short side of the magnetic body 11. Yet otherwise, the antenna device 10 of this embodiment of the present invention may include one or more through holes in addition to one or more projections and/or grooves on the one side of the magnetic body 11. As illustrated in FIGS. 1, 2A, 2B, and 2C, in this embodiment of the present invention, a pair of grooves 13 respectively having V-shaped cross sections is formed on both sides of the magnetic body 11, respectively. Specifically, the pair of grooves 13 extends in the axial direction indicated by X from one edge to the other edge of the magnetic body 11 near a longitudinal center of the magnetic body 11 in the axial direction indicated by Y.

As illustrated in FIGS. 2A, 2B, and 2C, in this embodiment of the present invention, a length D between one edge and a center position of the magnetic body 11 in the axial direction indicated by Y is either about 6 mm or about 12 mm when the length B of the long side is either about 12 mm or about 24 mm, respectively (i.e., the length D is half of the length B). A width E of the groove 13 can be set to about 3 mm, for example. The greatest depth of the groove 13 may be determined in view of rigidity of the magnetic body 11, and may be set to about 20 μm, for example. The present invention is not limited to the groove 13 having such exemplary dimensions and includes variants of the grooves having a different dimension from the exemplary dimensions as well.

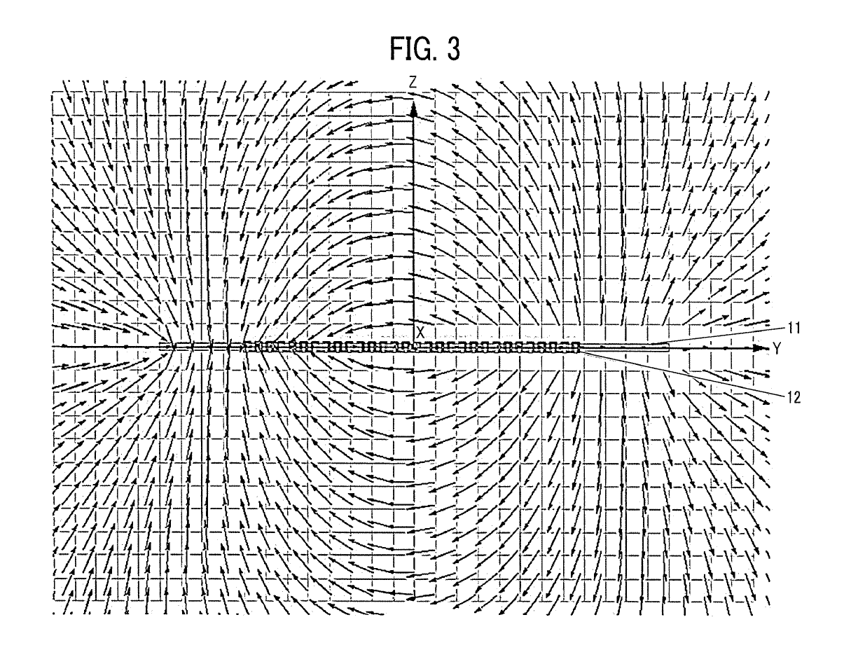

FIG. 3 is a diagram illustrating a simulation result of a magnetic field generated in a conventional antenna device excluding the groove 13 or the like. As illustrated in the drawing, since the groove 13 is excluded from the antenna device, a magnetic flux is uniformly generated around the magnetic body 11 extending from one edge to the other edge of the magnetic body 11. That is, in such a situation, the magnetic flux is directed only in the axial direction indicated by Y almost in a longitudinal center of the magnetic body in the direction parallel to a long side (i.e., the axial direction indicated by Y). That is, a magnetic flux is not generated in a normal direction of the magnetic body 11 (i. e., a direction indicated by Z perpendicular to the Y-axis of the magnetic body 11). Because of this, even when a loop antenna generally used in the NFC is brought close to (i.e., opposed to) a portion near the longitudinal center of the one side of the magnetic body, since a magnetic flux passing through the loop antenna is absent, magnetic coupling rarely occurs near the longitudinal center of the one side of the magnetic body. Consequently, communications becomes difficult near the longitudinal center of the one side of the magnetic body and accordingly communications available area becomes narrower.

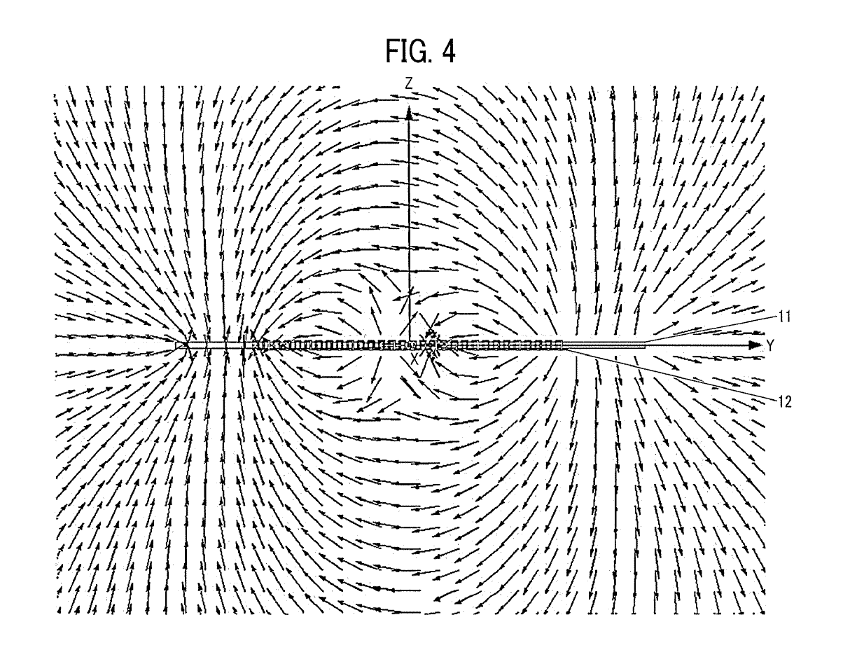

FIG. 4 is a diagram also illustrating a simulation result of generating a magnetic field in the antenna device 10 having the groove 13 according to this embodiment of the present invention illustrated in FIGS. 1, 2A, 2B, and 2C. Specifically, as illustrated in the drawings, due to formation of the grooves 13 on both sides of the magnetic body 11, a pair of loops of a magnetic flux occurs between both edges of the magnetic body 11 and the grooves 13, respectively. At the same time, a magnetic flux directed in the axial direction indicated by Z also appears even near the longitudinal center of the magnetic body 11 in the axial direction indicated by Y on each of both sides of the magnetic body 11.

Because of this, when another loop antenna (i.e., a counterpart loop antenna) is brought close to near the longitudinal center of the magnetic body 11 of the loop antenna in the axial direction indicated by Y, due to the presence of the magnetic flux on the magnetic body 11 in the axial direction indicated by Z, the magnetic flux of the loop antenna passes through the counterpart loop antenna. Consequently, in accordance with the law of right-handed screw rule, electric current flows in the loop antenna thereby enabling communications between the loop antenna and a counterpart loop antenna?. That is, although the conventional antenna device of FIG. 3 hardly establishes communications near the longitudinal center of the magnetic body 11 in the axial direction indicated by Y, the antenna device 10 of FIG. 4 can easily establish communications even near the longitudinal center of the magnetic body 11 in the axial direction indicated by Y thereby expanding a communicable range.

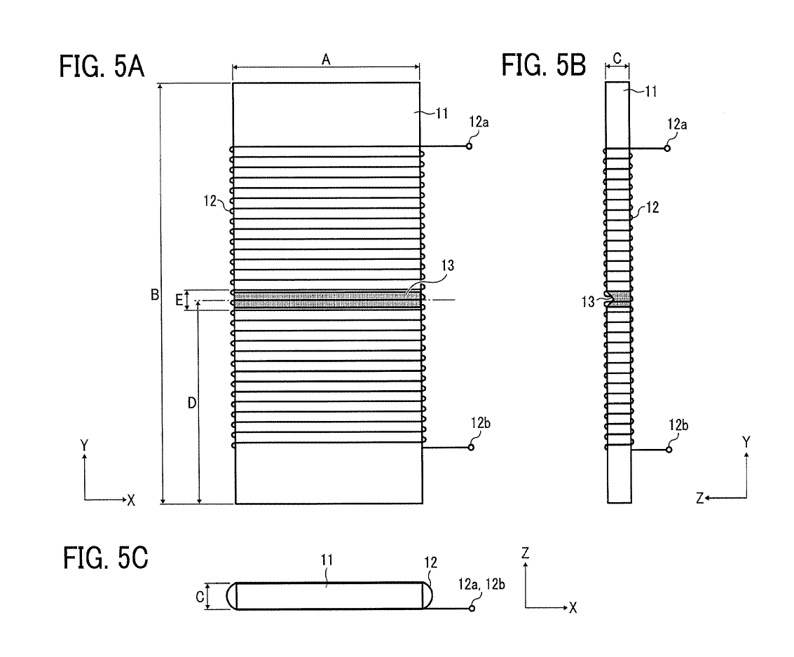

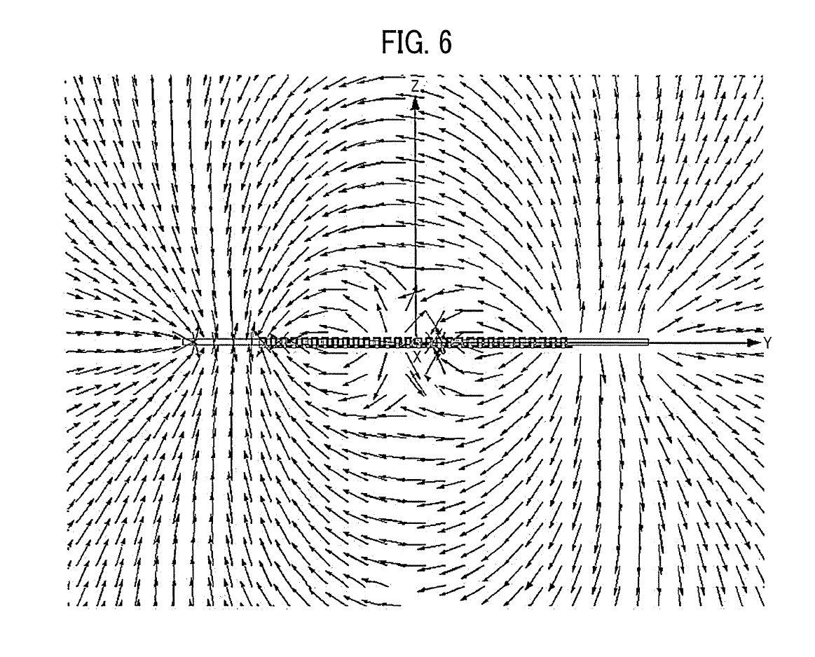

Now, another embodiment of the present invention is herein below described with reference to FIGS. 5A, 5B, and 5C and applicable drawings. That is, in the above-described embodiment of the present invention illustrated in FIGS. 1, 2A, 2B, and 2C, the pair of grooves 13 is formed on both sides of the magnetic body 11 with the grooves having the V-shapes, respectively. In this embodiment of the present invention, however, a single groove 13 may be only formed on one of both sides of the magnetic body 11 as illustrated in FIGS. 5A, 5B, and 5C. That is, even when the groove 13 is only formed on one of both sides of the magnetic body 11, a pair of loops of the magnetic flux again appears between the edges of the magnetic body 11 and the groove 13 similarly, so that a magnetic flux directed in the axial direction indicated by Z can appear near the longitudinal center of the magnetic body 11 in the axial direction indicated by Y as illustrated in FIG. 6.

In addition, since the groove 13 is only formed on one side of the magnetic body 11, a man-hour needed for processing the magnetic body 11 can be reduced while increasing rigidity of the magnetic body 11. As a result, the magnetic body 11 can have a great resistance to an impact on the magnetic body 11.

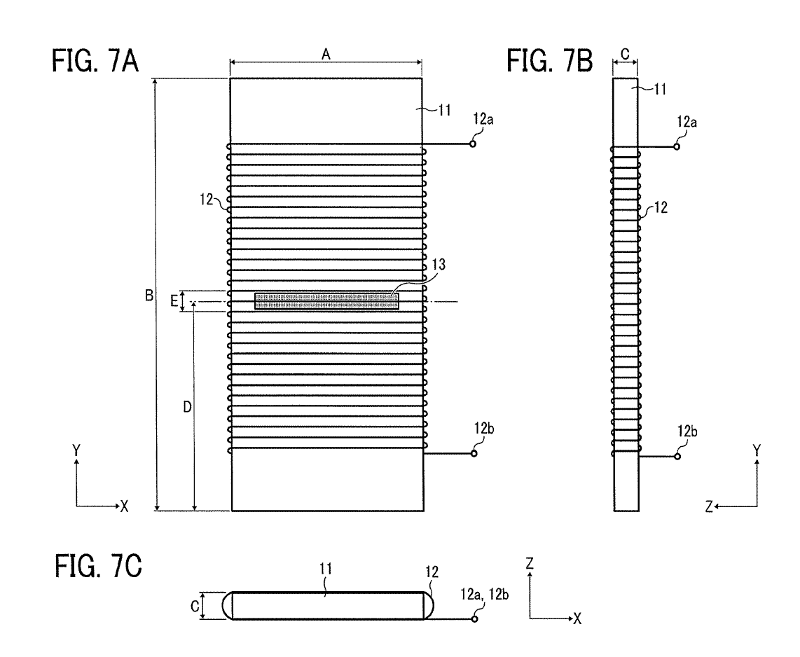

Now, yet another embodiment of the present invention is herein below described with reference to FIGS. 7A, 7B, and 7C and applicable drawings. That is, the above-described groove 13 at least formed on one of both sides of the magnetic body 11 does not need to be formed extending from one edge to the other edge on the magnetic body 11 in axial direction indicated by X (i.e., over the short side of the magnetic body 11). Specifically, the groove 13 may be only formed in a limited portion near a center of the magnetic body 11 in the axial direction indicated by X by a certain length as illustrated in FIGS. 7A, 7B, and 7C. In such a situation, the length of the groove 13 can be determined and set to be able to generate the magnetic flux in the axial direction indicated by Z. Again, either only one groove or a pair of grooves 13 may be formed on one of both sides or both sides, respectively, of the magnetic body 11 as well. As a modification of this embodiment of the present invention, the groove 13 can extend by a prescribed length either from one edge to a portion on the way to the other edge of the magnetic body 11 in the axial direction indicated by X or from the other edge to a portion on the way to the one edge of the magnetic body 11 in the axial direction indicated by X.

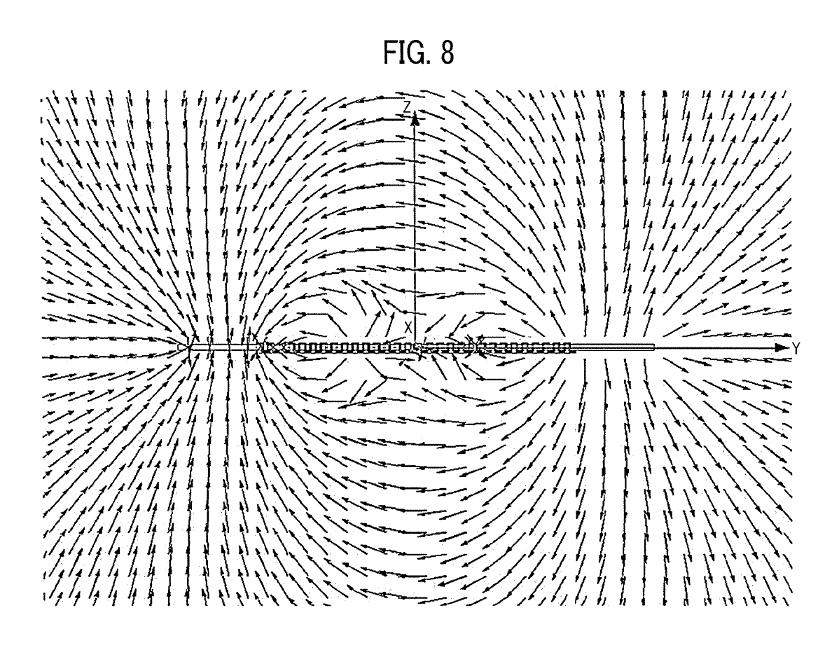

Hence, since the groove 13 is partially formed by the certain length in the axial direction indicated by X, a thickness of the magnetic body 11 does not entirely decrease in the direction, rigidity of the magnetic body 11 can be more effectively increased when compared to the embodiment of the present invention illustrated in FIGS. 4, 5A, 5B, and 5C. In addition, by wholly or partially forming the groove 13 only on one of both sides of the magnetic body 1, rigidity of the magnetic body 11 can be more effectively increased when compared to the magnetic body 11 having the pair of grooves on both sides of the magnetic body 11, respectively. Again, as illustrated in FIG. 8, as in the earlier described various embodiments of the present invention, the magnetic flux appears extending in the axial direction indicated by Z near the longitudinal center of the magnetic body 11 in the axial direction indicated by Y. Accordingly, communications become available in the longitudinal center of the magnetic body 11 in the axial direction indicated by Y, so that a communicable range can be expanded.

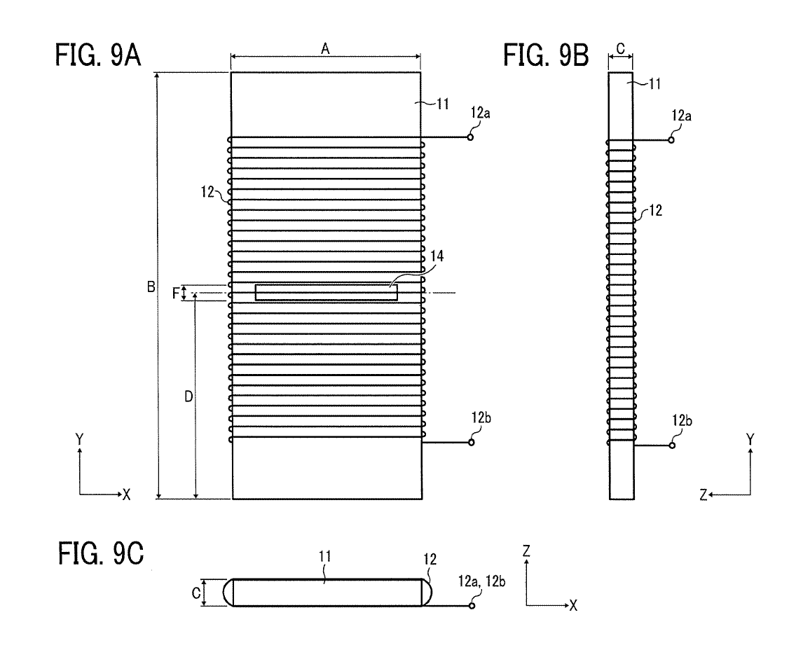

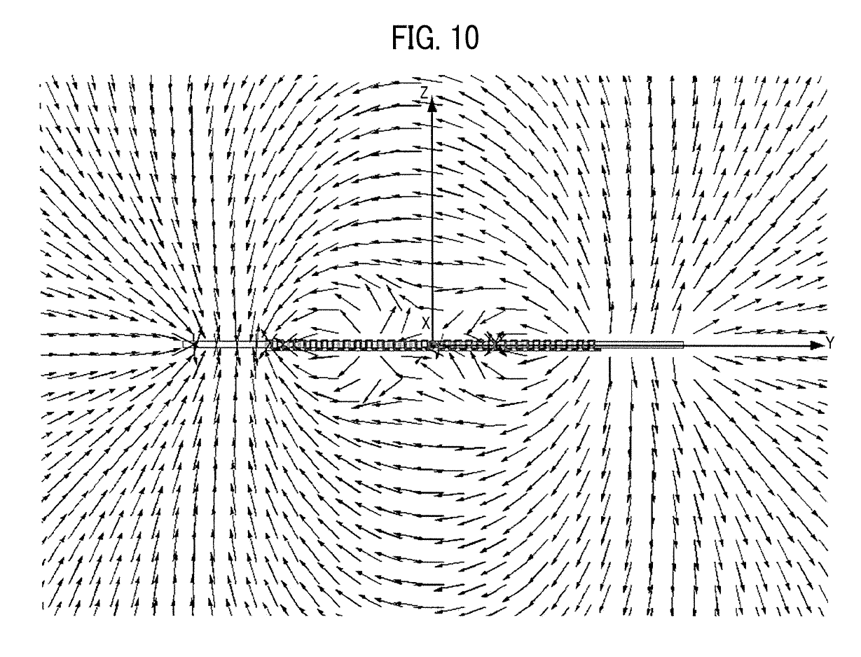

Now, yet another embodiment of the present invention is herein below described with reference to FIGS. 9A, 9B, and 9C and applicable drawings. That is, although it is heretofore described that the groove 13 is either wholly or partially formed in the magnetic body 11, the present invention is not limited to the groove 13 and includes variants of the groove 13 as described herein below in greater detail. Specifically, as illustrated in FIGS. 9A, 9B, and 9C, a through hole 14 may be formed in the magnetic body 11 penetrating the magnetic body 11 from one side to the other side on a rear side of the magnetic body 11 and extending in the axial direction indicated by X. That is, since the through hole 14 is formed in this way thereby providing a cavity in the magnetic body 11, a pair of loops of the magnetic flux can again appear between the edges of the magnetic body 11 and the through hole 14, and accordingly, a magnetic flux can be generated at the same time in the axial direction indicated by Z even near the longitudinal center of the magnetic body 11 in the axial direction indicated by Y as illustrated in FIG. 10.

In this embodiment of the present invention, as illustrated in FIG. 9A, a width F of the through hole 14 may be substantially the same with the width E of the groove 13. A length of the through hole 14 in the axial direction indicated by X may also be substantially the same with the length of the groove 13 in the same direction as well. However, the present invention is not limited to the above-described various dimensions, and can employ any width and any length as long as a magnetic flux properly arises in the axial direction indicated by Z.

When the depth of the groove 13 varies depending on a position in the axial direction indicated by Z, a magnetic flux also changes in the same direction in accordance with the variation of the groove 13, and accordingly characteristics of the antenna device such as inductance (L), etc., also varies. However, according to this embodiment of the present invention, since the through hole 14 is formed completely penetrating the magnetic body 11 without changing the depth of the through hole 14, the change in characteristics can be either reduced or suppressed.

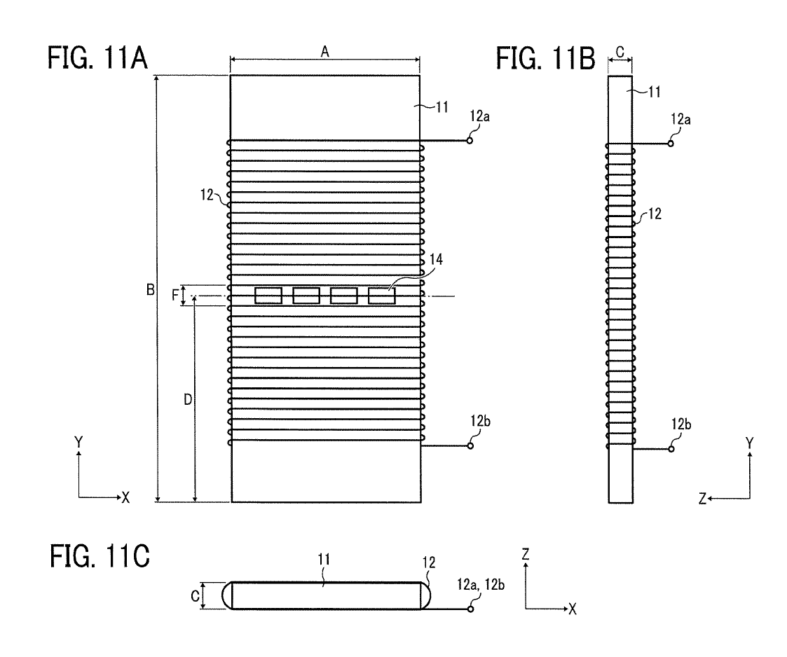

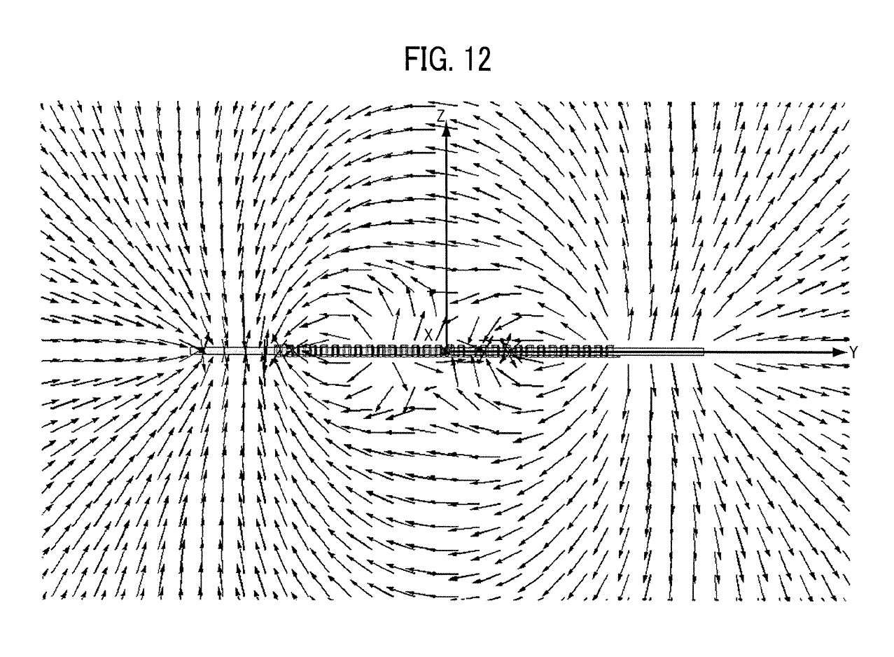

Now, yet another embodiment of the present invention is herein below described with reference to FIGS. 11A, 11B, and 11C and applicable drawings. That is, although only one through hole 14 is formed as described in the embodiment of the present invention with reference to FIGS. 9A, 9B, and 9C, the number of through holes 14 is not limited to one, and two or more through holes 14 may be formed as illustrated in FIGS. 11A, 11B, and 11C. Specifically, as illustrated in FIGS. 11A, 11B, and 11C, in this embodiment of the present invention, 4, four through holes 14 are formed on a line in the axial direction indicated by X. Again, according to this embodiment of the present invention, as illustrated in FIG. 12, multiple magnetic loops occur between both edges of the magnetic body 11 and the four through holes 14, and a magnetic flux can be generated at the same time in the axial direction indicated by Z even near the longitudinal center of the magnetic body 11.

Hence, with the configuration of FIGS. 11A, 11B, and 11C, since the four through holes are needed, a man-hour for processing the through holes increases. However, since the four through holes are almost formed by dividing the single oblong hole 14 as illustrated in FIGS. 9A, 9B, and 9C into four small holes while connecting neighboring small holes at three positions, rigidity of the magnetic body 11 can be more effectively enhanced than the single oblong hole 14 illustrated in FIGS. 9A, 9B, and 9C.

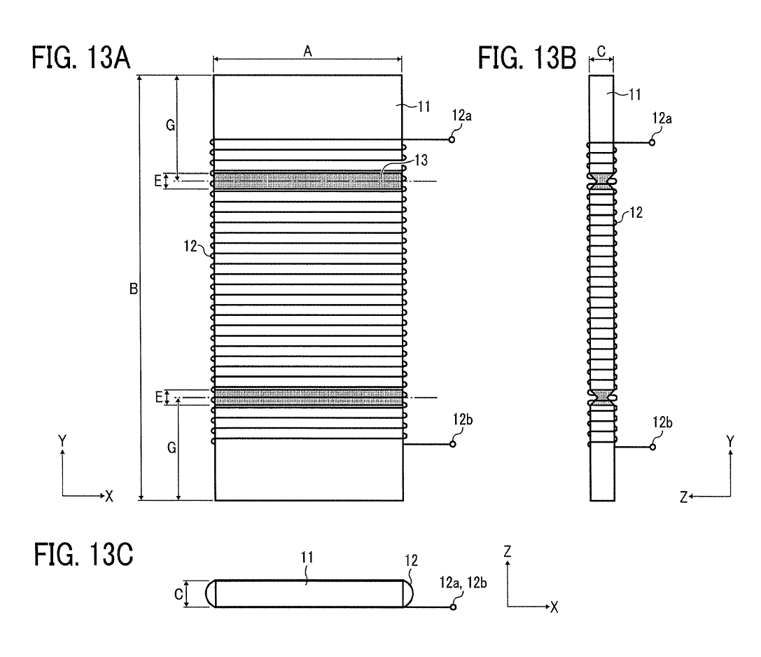

Now, yet another embodiment of the present invention is herein below described with reference to FIG.13A, 13B, and 13C and applicable drawings. That is, as described heretofore, to produce the magnetic flux on the magnetic body 11 in the axial direction indicated by Z near the longitudinal center of the magnetic body 11 in the axial direction indicated by Y, either one or more grooves 13 or one or more through holes 14 are formed near the longitudinal center of the magnetic body 11 in the axial direction indicated by Y. However, the antenna device 10 is lengthy enough in the axial direction indicated by Y, at almost middle portions between both edges of the magnetic body 11 and the longitudinal center of the magnetic body 11 in the axial direction indicated by Y, a magnetic flux in the axial direction indicated by Z may no longer exist again so that communications become difficult near the middle portions of the magnetic body 11.

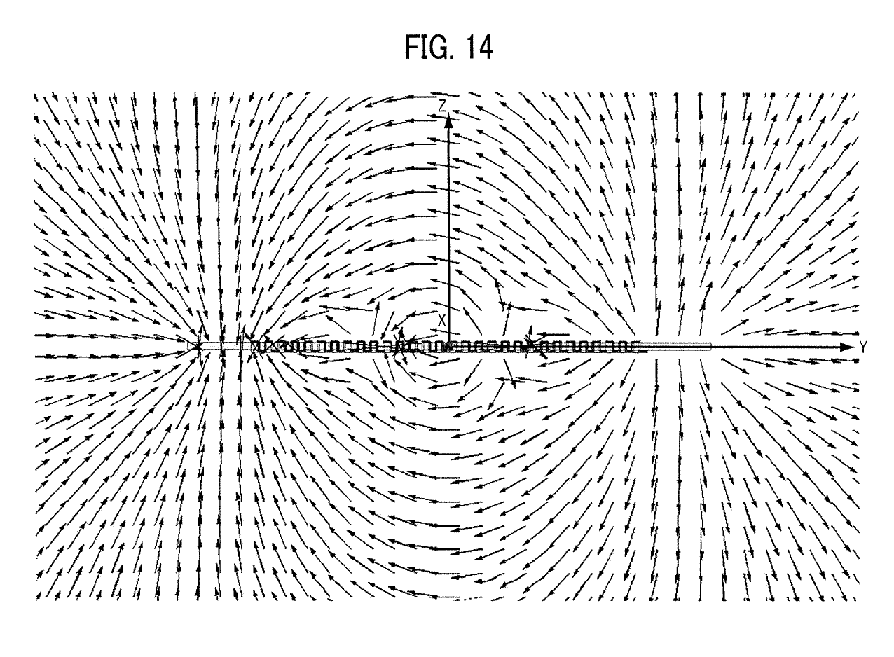

To resolve such a problem in this embodiment of the present invention, the number of grooves 13 is increased as illustrated in FIGS. 13A, 13B, and 13C. That is, in this embodiment, as illustrated in the drawings, a pair of grooves 13 is formed in the magnetic body 11 such that a longitudinal center of each of the grooves is distanced from corresponding one end of the magnetic body 11 in the axial direction indicated by Y by a length G. The number of grooves 13 or the length G may be determined as appropriate in accordance with a length B of the magnetic body 11 in the axial direction indicated by Y. Thus, as illustrated in FIG. 14, since two grooves 13 are formed, the magnetic fluxes are given rise to in the axial direction indicated by Z at many positions in the axial direction indicated by Y. With this, a communicable range can be broadened even in a relatively lengthy antenna device 10 in the axial direction indicated by Y. A depth and a width E of each of the grooves 13 of this embodiment of the present invention can be substantially the same as the depth and the width E of the groove 13 as employed in the above-described various embodiments of the present invention.

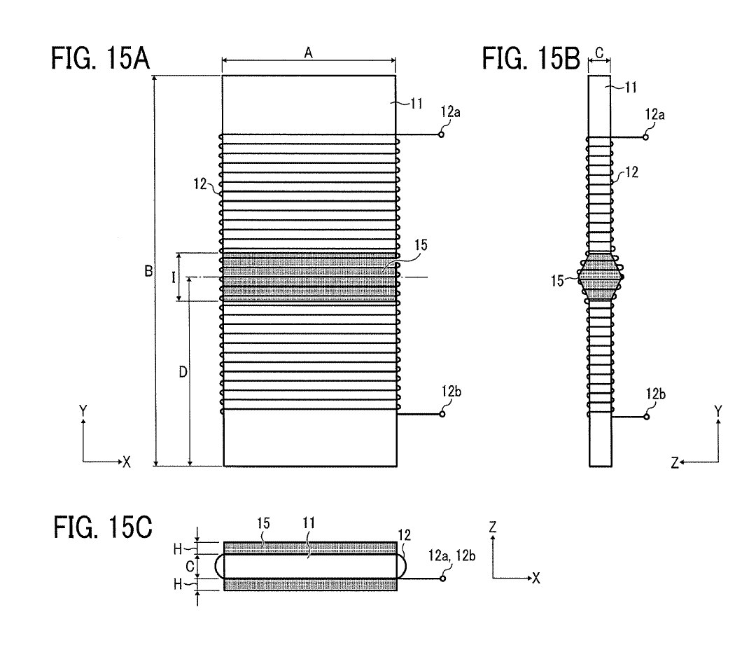

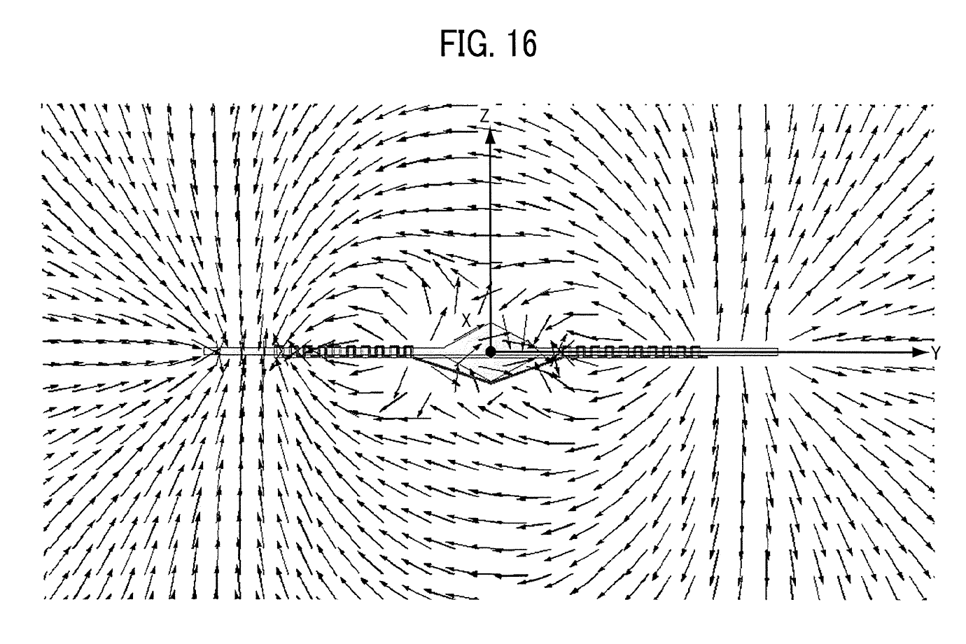

Now, yet another embodiment of the present invention is herein below described with reference to FIGS. 15A, 15B, and 15C, and applicable drawings as well. That is, the present invention is not limited to the magnetic body 11 having either the groove 13 or the through hole 14 and includes variants of the magnetic body 11 as long as the variants can give rise to a magnetic flux in the axial direction indicated by Z. Accordingly, one or more projections 15 may be provided, for example, as illustrated in FIGS. 15A, 15B, and 15C. Then, according to this embodiment of the present invention, as illustrated in the drawings, near the longitudinal center of the magnetic body 11 in the axial direction indicated by Y, a pair of projections 15 having a mountain-shape in a cross section of the magnetic body 11 is disposed on both sides of the magnetic body 11, respectively, while extending from one edge to the other edge of the magnetic body 11 in the axial direction indicated by X. A height H and a width I of the mountain-shape of each of the projections 15 can be determined to be values capable of properly giving rise to a magnetic flux in the axial direction indicated by Z on the magnetic body 11. Hence, with such projections 15, as illustrated in FIG. 16, the magnetic flux can be generated in the axial direction indicated by Z near the longitudinal center of the magnetic body 11 in the axial direction indicated by Y as generated when either the groove 13 or the through hole 14 is formed.

In addition, rigidity of the magnetic body 11 can be enhanced, because a thickness of a portion near the longitudinal center of the magnetic body 11 in the axial direction indicated by Y is increased by the pair of projections 15 in contrast to a situation in which either the groove 13 or the through hole 14 is provided. A tip of each of the projections 15 is not only sharpened as illustrated in FIGS. 15A, 15B, and 15C but also rounded as well.

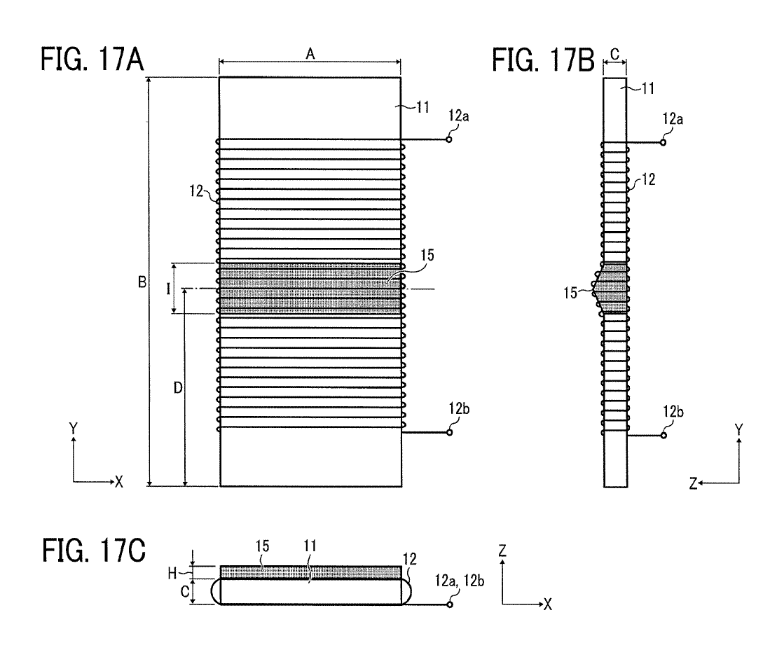

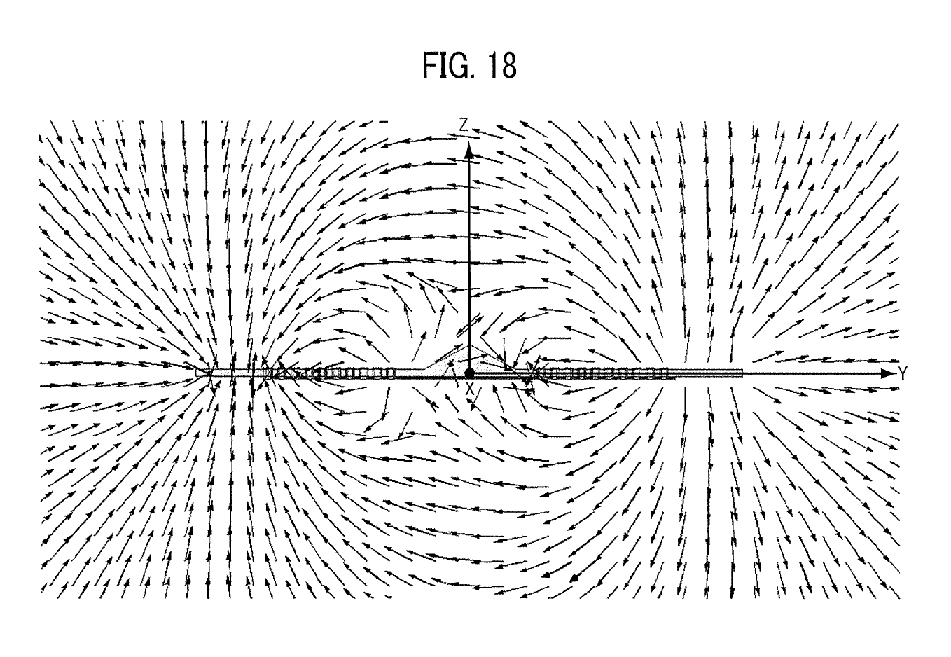

Now, yet another embodiment of the present invention is herein below described with reference to FIGS. 17A, 17B, and 17C, and applicable drawings as well. That is, although the pair of projections 15 is formed on both sides of the magnetic body 11, respectively, in the above-described embodiment of the present invention with reference to FIGS. 15A, 15B, and 15C, only one projection 15 may be provided on one of both sides of the magnetic body 11 as illustrated in FIGS. 17A, 17B, and 17C as in the earlier described embodiment of the present invention, in which only one groove 13 is provided. Again, with such a configuration, as illustrated in FIG. 18, a magnetic flux is given rise to in the axial direction indicated by Z on the magnetic body 11 almost in the longitudinal center of magnetic body 11 in the axial direction indicated by Y.

Accordingly, since the projection 15 is only formed on one side of the magnetic body 11, a man-hour needed to process of the magnetic body 11 can be reduced while saving material of the magnetic body 11. Again, as same as the groove 13 and the through hole 14, the projection 15 does not need to wholly extend from one edge to the other edge of the magnetic body 11 in the axial direction indicated by X as well. That is, the projection 15 may extend only by a prescribed length shorter than the side of the magnetic body 11 in the axial direction indicated by X as well. Also, the number of each of grooves 13 and projections 15 is not limited to one as that of the through hole 14 illustrated in FIGS. HA, 11B, and 11C, and may be two or more similarly arranged on a line in the axial direction indicated by X as well. In addition, similar to the number of grooves 13 illustrated in FIGS. 13A, 13B, and 13C, the number of each of through holes 14 and projections 15 is not limited one, and may be multiple to be arranged parallel to each other in the axial direction indicated by Y. Furthermore, the number of grooves 13 extending in the axial direction indicated by X in FIGS. 13A, 13B, and 13C is not necessarily one, and may be multiple to be arranged on a line in the axial direction indicated by X. Similarly, the number of each of through holes 14 and projections 15 extending in the axial direction indicated by X is not necessarily one, and may be multiple to be arranged on a line in the axial direction indicated by X as well.

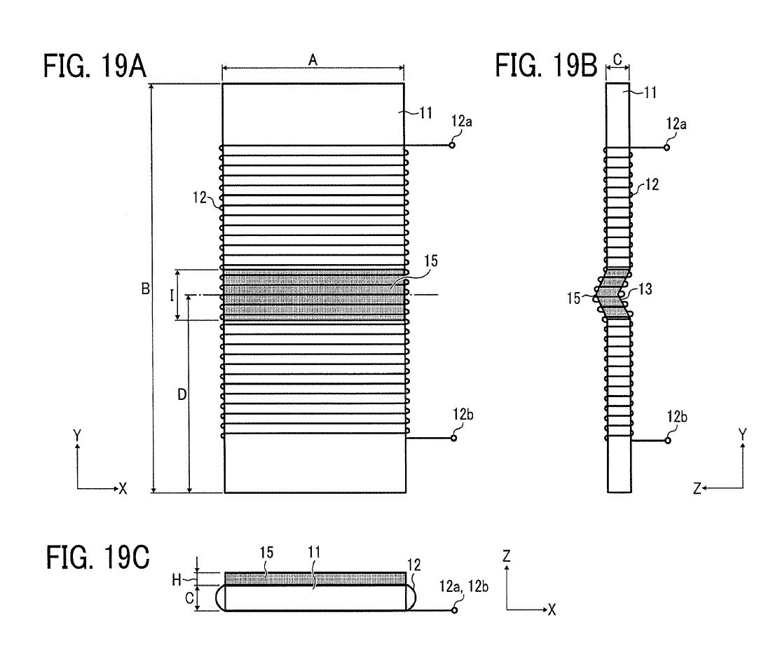

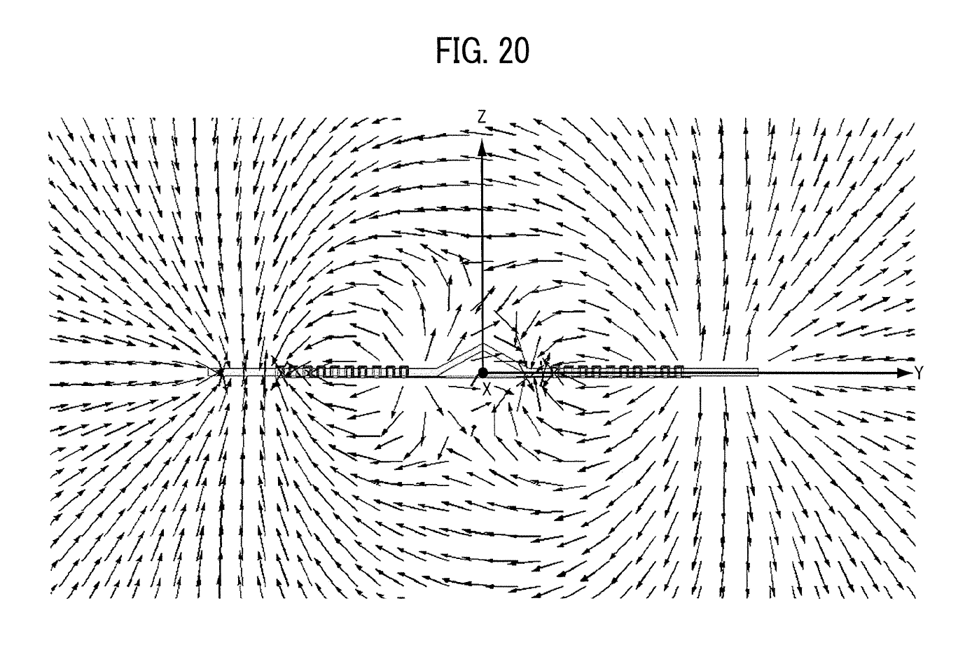

Now, yet another embodiment of the present invention is herein below described with reference to FIGS. 19A, 19B, and 19C, and applicable drawings as well. As described heretofore, various embodiments of the magnetic body 11 include one of one or more grooves 13, through holes 14, and projections 15 on either one side or both sides, respectively. However, as long as the magnetic body 11 of the antenna device 10 can give rise to a magnetic flux on the magnetic body 11 in the axial direction indicated by Z, the magnetic body 11 does not necessarily include only one of one or more grooves 13, through holes 14, and projections 15. That is, for example, one or more grooves 13 are formed on one side of the magnetic body 11 while forming one or more projections 15 on the other side of the magnetic body 11 at the same time as illustrated in FIGS. 19A, 19B, and 19C as well. Again, with this configuration, as illustrated in FIG. 20, near the longitudinal center of the magnetic body 11 in the axial direction indicated by Y, a magnetic flux can be generated in the axial direction indicated by Z as well.

Hence, since both of one or more grooves 13 and one or more projections 15 are formed in the magnetic body 11 at the same time as a pair, material needed to produce the magnetic body 11 can be saved more effectively than when only one or more projections 15 are formed on one or both sides of the magnetic body 11, respectively. In addition, a prescribed rigidity of the magnetic body 11 can be maintained more effectively than when only one of one or more through holes 14 and one or more grooves 13 are formed on the magnetic body 11. Again, a depth of a groove of one or more grooves 13 of the magnetic body 11 may be the same as that of the groove 13 as illustrated in FIGS. 2A, 2B, and 2C or the like. Also, a width of each of one or more grooves 13 and projections 15 of the magnetic body 11 can be substantially the same as that of the projection illustrated in FIGS. 15 and 17 as well. Further, a height I of the projection 15 of the magnetic body 11 can be substantially the same as that of the projection 15 of the magnetic body 11 illustrated in FIGS. 15A, 15B, 15C, 17A, 17B, and 17C as well.

Although the above-described embodiment of the present invention employs one or more grooves 13 and one or more projections 15 as a pair as described heretofore, the present invention is not limited to the above-described embodiment of the present invention. That is, as illustrated in FIGS. 11A, 11B, 11C, 13A, 13B, and 13C, since multiple grooves 13 and through holes 14 can be formed in the magnetic body 11, a combination of one or more grooves 13 and through holes 14, that of one or more through holes 14 and projections 15, and that of one or more grooves 13, one or more through holes 14, and one or more projections 15 can be formed on one of one and both sides of the magnetic body 11 as well. In addition, the width and the depth of at least one of the grooves 13, a width of at least one of the through holes 14, and a height and a width of at least one of the projections 15 can be different from a width and a depth of the other one of the grooves 13, a width of the other one of the through holes 14, and a height and a width of the other one of the projections 15, respectively. In any one of the above-described situations, the above-described various dimensions can be appropriately determined and set to be able to generate a magnetic flux on the magnetic body 11 in the axial direction indicated by Z.

As described heretofore, according to one embodiment of the present invention, by employing one or more grooves 13 and/or projections 15 on either one side or both sides of the magnetic body 11, respectively, or one or more through holes 14 in the magnetic body 11, the magnetic body 11 can generate a magnetic flux in the axial direction indicated by Z on the magnetic body 11 at a section of the magnetic body 11 needed to establish magnetic coupling. As a result, with such a magnetic body 11, a communicable range can be widened. Accordingly, since the communicable range is widened in this way, the antenna device 10 can successfully communicate with another antenna device of a communications counterpart included in a counterpart electronic apparatus 200 even when an optional section of the antenna device 10 is brought close to the other antenna device of the communications counterpart included in a counterpart electronic apparatus 200. As a result, communication error sometimes caused between the antenna devices can be reduced. The above-described advantage can be similarly obtained in the wireless electric power supply system as well.

That is, according to one embodiment of the present invention, a coil antenna device includes a planar magnetic body and a conducting wire wound around the planar magnetic body multiple times as a coil having a prescribed length in a direction parallel to a long side of the magnetic body. The magnetic body includes at least one irregular portion having a different cross-sectional shape from a cross-sectional shape of another portion of the magnetic body at an intermediate position of the long side of the magnetic body, at which the conducting wire is wound around the magnetic body. The at least one irregular portion extends parallel to a short side of the magnetic body.

According to another embodiment of the present invention, the communication error sometimes caused between the antenna devices can be more effectively reduced. That is, according to another embodiment of the present invention, the coil antenna device employs a short range magnetic coupling system to magnetically communicate with another coil antenna device of a communications counterpart located within a short range by sending and receiving signals of a prescribed frequency.

According to yet another embodiment of the present invention, the communication error sometimes caused between the antenna devices can be more effectively reduced. That is, according to yet another embodiment of the present invention, a diameter of the conducting wire is about 50 μm when the prescribed frequency of a signal transmitted between the coil antenna device and said another coil antenna device is about 13.56 MHz. The conducting wire is evenly wound around the magnetic body about 30 times at an interval of about 0.25 μm.

According to yet another embodiment of the present invention, the communication error sometimes caused between the antenna devices can be more effectively reduced. That is, according to yet another embodiment of the present invention, the conducting wire is coated with enamel, and a diameter of the conducting wire coated with the enamel is about 69 μm.

According to yet another embodiment of the present invention, the communication error sometimes caused between the antenna devices can be more effectively reduced. That is, according to yet another embodiment of the present invention, the planar magnetic body is made of either sintered ferrite or ferromagnetic material.

According to yet another embodiment of the present invention, the communication error sometimes caused between the antenna devices can be more effectively reduced. That is, according to yet another embodiment of the present invention, the conducting wire is made of one of copper, silver, gold, and conductive polymer to conduct an electric current through the conducting wire.

According to yet another embodiment of the present invention, the communication error sometimes caused between the antenna devices can be more effectively reduced. That is, according to yet another embodiment of the present invention, the at least one irregular portion is at least one groove, at least one through hole, at least one projection, or a combination of at least two of the at least one groove, the at least one projection, and the at least one through hole.

According to yet another embodiment of the present invention, the communication error sometimes caused between the antenna devices can be more effectively reduced. That is, according to yet another embodiment of the present invention, the planar magnetic body is a thin sheet.

According to yet another embodiment of the present invention, the communication error sometimes caused between the antenna devices can be more effectively reduced. That is, according to yet another embodiment of the present invention, the irregular portion extends for a prescribed length in a direction parallel to a short side of the magnetic body at substantially a center of the long side of the magnetic body.

According to yet another embodiment of the present invention, the communication error sometimes caused between the antenna devices can be more effectively reduced. That is, according to yet another embodiment of the present invention, the prescribed length is equivalent to the short side of the magnetic body.

According to yet another embodiment of the present invention, the communication error sometimes caused between the antenna devices can be more effectively reduced. That is, according to yet another embodiment of the present invention, the at least one irregular portion includes multiple grooves, projections, or through holes aligned parallel to the short side of the magnetic body.

According to yet another embodiment of the present invention, the communication error sometimes caused between the antenna devices can be more effectively reduced. That is, according to yet another embodiment of the present invention, the at least one irregular portion includes at least one projection on one side of the magnetic body at substantially a center of the long side of the magnetic body, and at least one groove on another side of the magnetic body at substantially the center of the long side of the magnetic body.

According to yet another embodiment of the present invention, the communication error sometimes caused between the antenna devices can be more effectively reduced. That is, according to yet another embodiment of the present invention, the at least one irregular portion includes multiple grooves, multiple projections, or multiple through holes extending parallel to each other and to the short side of the magnetic body at two or more intermediate positions of the long side of the magnetic body.

Numerous additional modifications and variants of the present disclosure are possible in light of the above teachings. It is therefore to be understood that within the scope of the appended claims, the present disclosure may be practiced otherwise than as specifically described herein. For example, the coil antenna device is not limited to the above-described various embodiments and modifications may be made as appropriate. Further, the electronic apparatus is not limited to the above-described various embodiments and modifications may be altered as appropriate as well. Further, the method of producing a coil antenna device is not limited to the above-described various embodiments and modifications may be altered again as appropriate. For example, a step of the method of producing the coil antenna device can be altered as appropriate as well.

What is claimed is:

1. A coil antenna device comprising:
a planar magnetic body; and
a conducting wire wound around the planar magnetic body multiple times as a coil having a prescribed length in a direction parallel to a long side of the magnetic body,
wherein the magnetic body includes at least one irregular portion having a different cross-sectional shape from a cross-sectional shape of another portion of the magnetic body at an intermediate position of the long side of the magnetic body, at which the conducting wire is wound around the magnetic body, the at least one irregular portion extending parallel to a short side of the magnetic body.

2. The coil antenna device according to claim 1,
wherein the coil antenna device employs a short range magnetic coupling system to magnetically communicate with another coil antenna device of a communications counterpart located within a short range by sending and receiving signals of a prescribed frequency.

3. The coil antenna device according to claim 2,
wherein a diameter of the conducting wire is about 50 μm when the prescribed frequency of a signal transmitted between the coil antenna device and said another coil antenna device is about 13.56 MHz,
wherein the conducting wire is evenly wound around the magnetic body about 30 times at an interval of about 0.25 mm.

4. The coil antenna device according to claim 2,
wherein the conducting wire is coated with enamel,
wherein a diameter of the conducting wire coated with the enamel is about 69 μm.

5. The coil antenna device according to claim 1,
wherein the planar magnetic body is made of either sintered ferrite or ferromagnetic material.

6. The coil antenna device according to claim 1,
wherein the conducting wire is made of one of copper, silver, gold, and conductive polymer to conduct an electric current through the conducting wire.

7. The coil antenna device according to claim 1,
wherein the at least one irregular portion is at least one groove, at least one through hole, at least one projection, or a combination of at least two of the at least one groove, the at least one projection, and the at least one through hole.

8. The coil antenna device according to claim 1,
wherein the planar magnetic body is a thin sheet.

9. The coil antenna device according to claim 1,
wherein the irregular portion extends for a prescribed length in a direction parallel to a short side of the magnetic body at substantially a center of the long side of the magnetic body.

10. The coil antenna device according to claim 9,
wherein the prescribed length is equivalent to the short side of the magnetic body.

11. The coil antenna device according to claim 1,
wherein the at least one irregular portion includes multiple grooves, projections, or through holes aligned parallel to the short side of the magnetic body.

12. The coil antenna device according to claim 1,
wherein the at least one irregular portion includes;
at least one projection on one side of the magnetic body at substantially a center of the long side of the magnetic body, and
at least one groove on another side of the magnetic body at substantially the center of the long side of the magnetic body.

13. The coil antenna device according to claim 1,
wherein the at least one irregular portion includes multiple grooves, multiple projections, or multiple through holes extending parallel to each other and to the short side of the magnetic body at two or more intermediate positions of the long side of the magnetic body.

14. An electronic apparatus comprising the coil antenna device according to claim 1,
wherein the coil antenna device either wirelessly establishes communications or wirelessly supplies electricity to another coil antenna device located within a short range acting as either a communications counterpart or an electric power supply destination, respectively.

15. The electronic apparatus according to claim 14, further comprising a communication unit connected to both ends of the conducting wire wound around the planar magnetic body.

16. The electronic apparatus according to claim 15,
wherein the communication unit of the coil antenna device that wirelessly establishes the communications comprises:
a transmitter to transmit data to said another coil antenna device of the communications counterpart; and
a receiver to receive data from said another coil antenna device of the communications counterpart,
wherein each of the transmitter and the receiver includes a modulator, a demodulator, a memory circuit, and a control circuit.

17. The electronic apparatus according to claim 15,
wherein the communication unit of the coil antenna device is connected to a commercial alternating current electric power supply,
wherein the communication unit includes:
an electric power supply circuit to wirelessly supply electricity to said another coil antenna device; and
a power receiving circuit to receive electricity from said another coil antenna device.

18. The electronic apparatus according to claim 14,
wherein the electronic apparatus that wirelessly establishes communications is one of a radio frequency identification tag, an integrated circuit card, a radio frequency identification reader writer, a mobile phone, a smartphone, a tablet computer terminal, a laptop personal computer, a personal digital assistant, and a game console.

19. The electronic apparatus according to claim 14,
wherein the electronic apparatus that wirelessly supplies electricity is one of an electric toothbrush, an electric shaver, a cordless phone, a cordless iron, an electric bed, an electric car, an electric wheelchair, and an electric bicycle.

20. A method of producing a coil antenna device that wirelessly establishes communications or supplies electricity to another coil antenna device located within a short range, the method comprising:
forming at least one groove, at least one projection, or at least one through hole in a planar magnetic body parallel to a short side of the planar magnetic body at an intermediate position of a long side of the planar magnetic body;
winding a conducting wire around the planar magnetic body multiple times over the at least one groove, the at least one projection, or the at least one through hole as a coil; and
connecting both ends of the conducting wire wound around the planar magnetic body to a communication unit and forming a magnetic field on the planar magnetic body by generating a first magnetic flux extending from one end to another end of the coil of the coil antenna device and a second magnetic flux extending from the one end of the coil of the coil antenna device to the intermediate position of the long side of the planar magnetic body.
